(19) United States
(12) Patent Application Publication
(10) Pub. No.: US 2012/0119861 A1
(43) Pub. Date: May 17, 2012

(54) Permanent Magnets Array for Planar Magnetron

(75) Inventors: Yunjun Tang, Pleasanton, CA (US); Yicheng Sun, Fremont, CA (US)

(73) Assignee: PLASMA INNOVATION LLC, Pleasanton, CA (US)

(21) Appl. No.: 12/946,858

(22) Filed: Nov. 16, 2010

(51) Int. Cl. H01F 7/02

(52) U.S. Cl. 335/306

(57) ABSTRACT

Permanent magnets array for use in a planar magnetron in which magnets in a magnet-segment is arranged in a Halbach array with their magnetization directions alternating in directions perpendicular with each other. The magnet-segments are closely packed to form different shapes, such as heart, square, circular . . . , in a Halbach Array style, which leads to minimum magnetic flux loss. Such arrangement of permanent magnets will also reinforce the magnetic field on one side of the array while cancel the field to near zero on the other side. The reinforced field strength is twice as large on the side on which the flux is confined. The permanent magnets arrangement and the resulting stationary and/or rotating planar magnetron, provides the high magnetic flux density and uniform flux distribution need to penetrate thick sputtering target, and increased not only the target usage, but also the usable the target life time.

### REFERENCE CITED

### US patent Documents

| | | | |
|---|---|---|---|
| 4,622,122 | November 1986 | Richard F. Landau | 204/298 |
| 4,872,964 | October 1989 | Masafumi Suzuki et al. | 204/298 |
| 5,262,028 | November 1993 | Barry W. Manley | 204/192.12 |
| 5,865,970 | February 1999 | Richard Stelter et al. | 204/298.19 |
| 6,159,351 | December 2000 | Hussain J'Afer et al. | 204/298.19 |
| 6,183,614 B1 | February 2001 | Jianming Fu et al. | 204/298.2 |
| 7,182,843 B2 | February 2007 | Richard Stelter at al. | 204/192.2 |
| 7,223,322 B2 | May 2007 | Mark A. Bernick | 204/192.12 |

### FIELD OF INVENTION

This present invention relates to permanent magnets array, and more specifically to permanent magnets array that can be used in a sputtering magnetron to create a magnetic field that passing through a target material for sputtering process.

### BACKGROUND ART

Sputtering is the most widely used method for deposit thin film materials in the manufacturing of semiconductor and other microelectronic devices. Sputtering basically is glow discharge between a cathode and anode in a vacuum. In the process, an inert gas, such as Ar, is introduced into a vacuum system. The cathode is composed of a target material, such as Cu, which is applied with high enough negative potential to discharge the gas and form continuous plasma. Ions of the gas are accelerated to bombard the target and knock off the target atoms to deposit onto substrates, such as Si wafer. In the sputtering process, magnets array is usually employed at the back of the sputtering target to concentrate the electrons to spiral through the plasma on the surface of the sputtering target, thus enhance the local plasma density and increase the ion bombard rate onto the target. In this way, more atoms are sputtered off the target and deposit onto substrate. This process with magnets array to enhanced ionization and sputtering rate is called “magnetron sputtering”. Although there are many different magnets arrays of magnetron, magnetrons are based on E X B fields. A magnets array usually constituted of many pairs of magnets. Each pair has one magnetic pole, such as North Pole, adjacent by another opposite magnetic pole, such as South Pole. The magnetic field line produced by the pair of magnets passes through the target, forming an arc magnetic field line on top of the target between the two poles. Magnets pairs are arranged closely to form a magnetic flux pattern. In rotating magnetron, this pattern usually called “heart”, “apple”, etc. shapes in prior art. Electrons are trapped in this magnetic field pattern, which enhanced the efficiency of the discharge. The positive ions produced during the enhanced discharge process will bombard the target driven by its negative potential. In sputtering process, the design of the magnets array of magnetron is the key for magnetron sputtering. Optimized magnets array design in sputtering can
1. Enhance the sputtering rate;
2. Improve the thickness uniformity of the film deposited on the substrates;
3. Increase the sputtering target usage;
4. Increase the usable target lift time for one pump down run for a sputtering system, namely, a thicker target can be used for sputtering. This is very important, especially for magnetic material target, such as Ni, Co, Fe, NiFe, CoFe, CoPt, . . . .

In planar magnetron sputtering, rotating magnetron design is widely adopted because it can significantly improve the uniformity of the sputtered film, due to its rotating: once the magnetic field pattern formed by the magnets array is uniform, then the magnetic field line passing through the target surface will be distributed very uniform on the target surface; It can also increase the target usage since the magnetic field pattern formed by the magnets can be arranged to spread widely cross target surface, thus most area of the target will be sputtered to increase the target usage.

However, there are several issues with planar magnetron design of prior art.
1. Those magnet pairs are arranged separately. This causes not only the leaking of the magnetic flux and existence of fringing flux which reduce the magnetic field strength at the target surface, but most importantly, introducing non-uniform distribution of the magnetic field pattern formed by the magnets array.
2. A soft magnetic supporting plate, such as Fe, is always attached to the entire magnetic array on one side to shield the magnetic flux produced by the array. However, this will cause magnetic energy loss in the Fe plate, which in return will reduce the magnetic field strength produced at the target surface.

### SUMMARY OF THE INVENTION

The present invention includes permanent magnets array that embodied in a sputtering magnetron. A permanent magnets array for use in a planar magnetron in which magnets in magnet-segments are arranged in a Halbach array, i.e. with their magnetization directions alternating in directions perpendicular with each other. The magnet-segments are closely packed to form different shapes, such as heart, square, circular . . . , in a Halbach array style, which leads to minimum magnetic flux loss. Such arrangement of permanent magnets will also reinforce the magnetic field on one side of the array while cancel the field to near zero on the other side. The reinforced field strength is twice as large on the side on which the flux is confined. This permanent magnets arrangement and the resulting stationary and/or rotating planar magnetron, provides the high magnetic flux density and uniform flux distribution needed to penetrate thick sputtering target, and increase not only the target usage, but also the usable target life time.

### BRIEF DESCRIPTION OF THE DRAWINGS

FIG. 1 illustrates a prior art of permanent magnets structure that may be used in a sputtering magnetron.

FIG. 2 illustrates a prior art of permanent magnet-segment in a magnets structure that may also be used in a sputtering magnetron.

FIG. 3 illustrates a prior art of Halbach array of permanent magnets.

FIG. 4 illustrates an embodiment of present invention of a magnet-segment that can be embodied in a sputtering magnetron.

FIG. 5 illustrates another embodiment of present invention of a magnet-segment that can be embodied in a sputtering magnetron.

FIG. 6 illustrates further embodiment of present invention of a magnet-segment that can be embodied in a sputtering magnetron.

FIG. 7a illustrates an embodiment of present invention of a permanent magnets array that can be embodied in a sputtering magnetron.

FIG. 7b illustrates another embodiment of present invention of a permanent magnets array that can be embodied in a sputtering magnetron.

FIG. 8a illustrates further embodiment of present invention of a permanent magnets array that can be embodied in a sputtering magnetron.

FIG. 8b illustrates further embodiment of present invention of a permanent magnets array that can be embodied in a sputtering magnetron.

### DETAILED DESCRIPTION

The following description is provided in the context of particular applications and the details, to enable any person skilled in the art to make and use the invention. However, for those skilled in the art, it is apparent that various modifications to the embodiments shown can be practiced with the generic principles defined here, and without departing the spirit and scope of this invention. Thus, the present invention is not intended to be limited to the embodiments shown, but is to be accorded the widest scope consistent with the principles, features and teachings disclosed here.

The present invention relates to a configuration of a dipole permanent magnet structure for generating an external magnetic fields which can be embodied in a sputtering magnetron for use in a magnetron sputtering system.

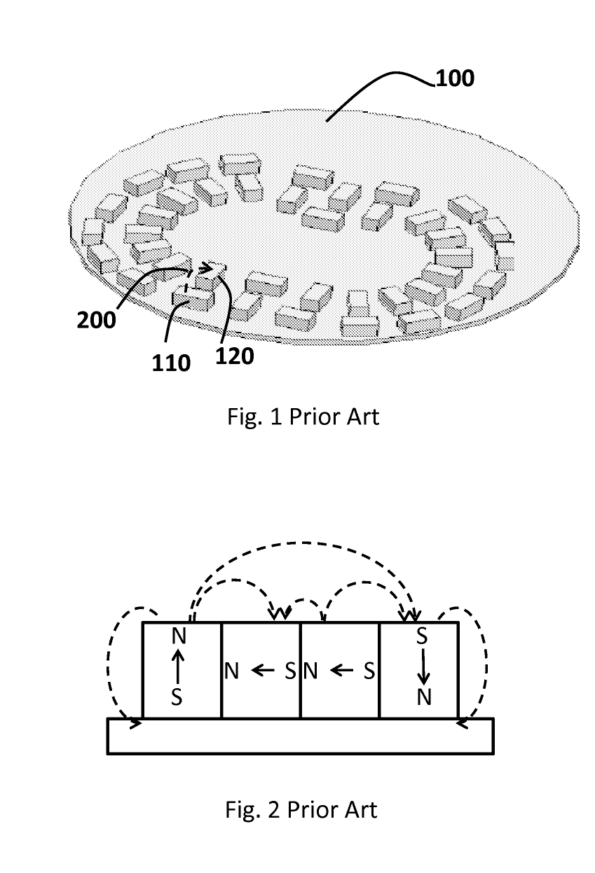

With reference to FIG. 1, a prior art dipole magnetic structure that may be embodied in a rotating magnetron used in a sputtering system is shown. The structure is composed of pairs of magnets, to form a “Heart”, “Apple”, or other similar shapes, and all the magnets are attached onto a soft magnetic plate 100, such as Fe. For each pair, such as, permanent magnet 110 and permanent magnet 120, their magnetic orientation is perpendicular to the soft magnetic plate 100, with North Pole of magnet 110 pointing up, and North Pole of magnet 120 pointing down. The soft magnetic plate 100 here is to 1) support the permanent magnets structure; 2) Forming a return path for the magnetic flux produced by the magnets, thus shielding the magnetic flux below. Each pair of magnets generates a closed loop magnetic field flux 200, and all the magnets can produce an “arc” of magnetic flux path. During sputtering process, such magnetron is placed above the back of a target material and rotating. With the magnetic flux passing through the target, forming an “arc” of magnetic flux path on top of the target surface, trapping electrons to form and sustain the plasma, ions to bombard the target, sputtering the atoms out of the target to deposit onto a substrate. However, there is significant magnetic flux loss in this prior art:
1. Magnetic flux loss in the soft magnetic plate;
2. Since the magnets are not closely packed, leakage flux and fringing flux are severe in between the magnets.
3. Most importantly, magnetic flux distribution is also not very uniform along the “arc” since the magnets are not distributed evenly.

With reference to FIG. 2, a side view of a further prior art of a dipole magnetic structure that may be embodied in a magnetron used in a sputtering system is shown. In this prior art, magnets are placed between salient poles of a magnetron dipole emphasizing at spread the external magnetic field of the sputtering magnetron over a larger area of the target. One of the cost prohibitive factors of sputtering is the usable target life time of the target in a pump down run of a sputtering system. In a word, a manufacturer utilizing a sputtering magnetron would be happy upon any process that would allow the use of thicker target that would be consumed uniformly over an extended life time. This is even more critical for sputtering a thick magnetic material target. It is well known that the deposition of a magnetic material adds complexity to the sputtering process because the magnetic field generated by the permanent magnets of the magnetron is absorbed by the magnetic target due to its high magnetic permeability. It is therefore necessary that magnets array of the magnetron should be able to produce a strong enough magnetic field on top of the target surface after passing through the magnetic target.

For this prior art, since the external magnetic field produced by the magnets is wide spread on the target, the magnetic field strength is largely reduced. Although it can increase the usage of the target, it inevitably reduces the capability to sputtering the thicker targets, which reduces overall the usable target life time.

In present invention, the design of the permanent magnets arrangement and the resulting stationary and/or rotating planar magnetron provides the high magnetic flux density and uniform flux distribution needed to penetrate thick production target, and increase not only the target usage, but also the usable target life time. Most importantly, the permanent magnets are arranged closely in a Halbach array style, which leads to minimum magnetic flux loss.

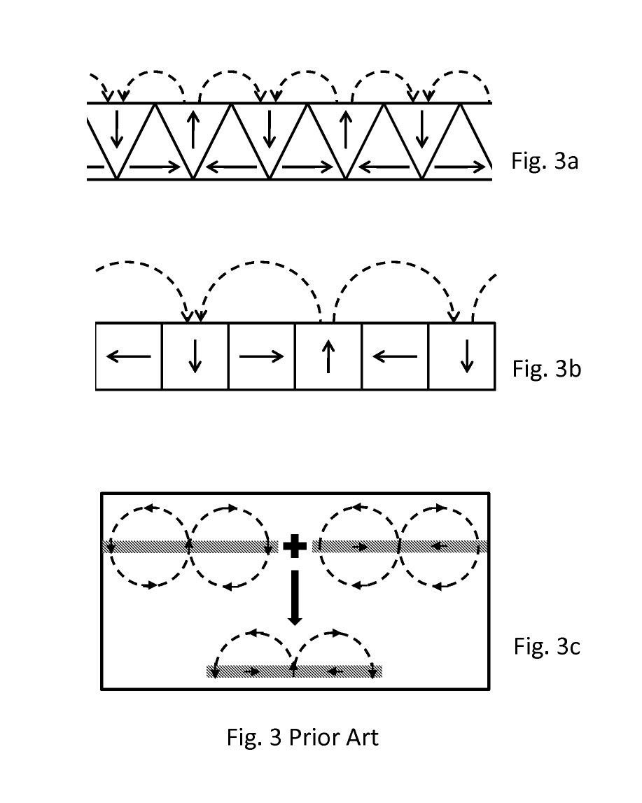

As shown in FIG. 3a and FIG. 3b, two typical Halbach arrays are illustrated. In Halbach array, adjacent magnets are arranged with their magnetization directions alternating in directions perpendicular with each other. As shown in FIG. 3c, the field above the plane is in the same direction for both structures, but the field below the plane is in opposite directions. Such arrangement of permanent magnets will reinforce the magnetic field on one side of the array while cancel the field to near zero on the other side. The magnetic field is thus enhanced on one side and cancelled on the other side, which is called “a one-sided flux”. The advantages of one sided flux distribution are twofold:
1. The field is twice as large on the side on which the flux is confined;
2. No stray field is produced on the opposite side. This helps with field confinement.

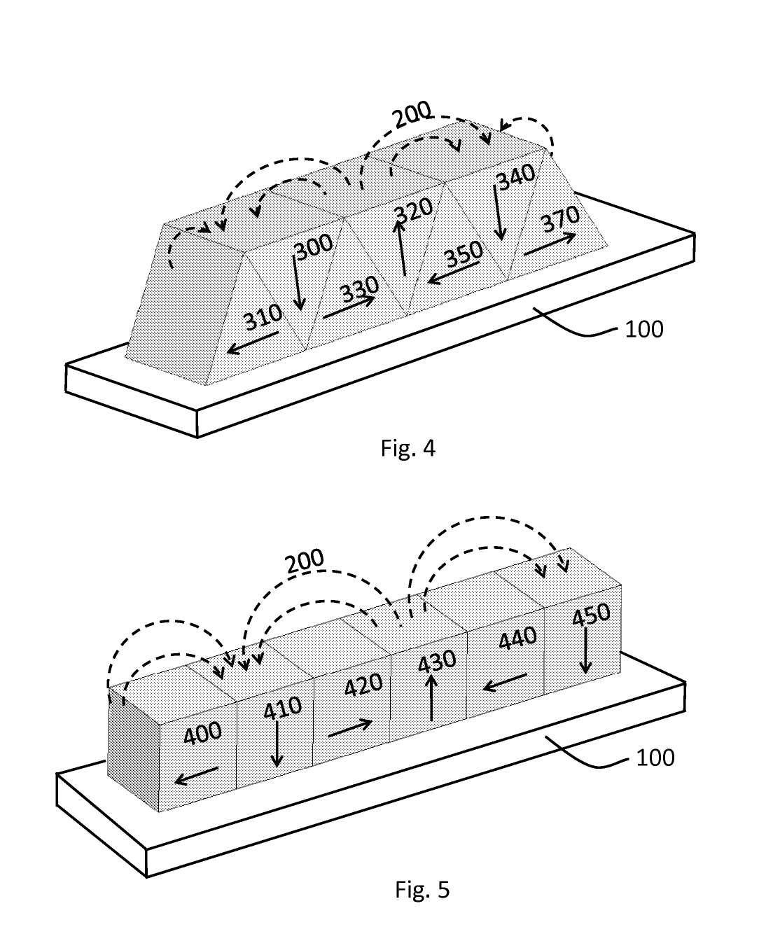

FIG. 4 illustrates an embodiment of a permanent magnet-segment that may be embodied in a magnets arrangement in a magnetron of present invention. All magnets are made of permanent magnetic materials, such as NdFeB, SmCo, AlNiCo . . . . The magnets are in triangular shaped, and closely packed and located on a supporting plate 100. The supporting plate typically can be non-magnetic materials, like, Al, plastic, stainless steel; or it can also be magnetic material, such as Fe. When magnetic plate is used, it can also be help to shield the magnetic flux when the magnets are not closely packed. The number of magnets can be varied in the arrangement, such as, 4, 5, 6, 7, 8, 9 . . . . The magnetization direction of the top magnet 320 is vertically pointing up, and the magnetization direction of its top adjacent magnets 300, 340 is vertically pointing down. The magnetization orientation of the bottom magnets, such as 310, 330, 350 and 370 should be perpendicular to the directions of top magnets 300, 320, 340, and each magnet has opposite direction with its adjacent magnets. With magnetization direction of the top magnet, such as magnet 320, pointing up, its two adjacent bottom magnets 330 and 350 should have their magnetization directions pointing towards the bottom of magnet 320, such that a closed magnetic flux loop is formed on the top of the magnet-segment, and no magnetic flux leak below the bottom of the magnet-segment. With magnetization direction of the top magnet pointing down, such as magnet 300, its two adjacent bottom magnets 310 and 330 should have their magnetization directions pointing away from the bottom of magnet 300, such that a closed magnetic flux loop is also formed on the top of the magnet-segment, and no magnetic flux leak below the bottom of the magnet-segment. Such arrangement of magnets will eliminate any magnetic flux loss below the bottom magnets, and should double the magnetic field strength 200 above the top magnets.

FIG. 5 illustrates an alternative embodiment of the permanent magnet-segment of present invention in which the rectangular shaped magnets are closely packed and sit on a supporting plate 100. The number of magnets can also be varied in the arrangement, such as, 4, 5, 6, 7, 8, 9 . . . . The magnetization direction of the magnet 430 is vertically pointing up, and the magnetization direction of its adjacent magnets 420, 440 is perpendicular to the direction of magnets 430, and both pointing towards magnet 430, such that a closed magnetic flux loop is formed on the top of the magnet-segment, and no magnetic flux leak below the bottom of the magnet-segment. With magnetization direction of the magnet pointing down, such as magnet 410, its two adjacent magnets 400 and 420 should have their magnetization directions pointing away from the magnet 410 from both directions, such that a closed magnetic flux loop is formed on the top of the magnet-segment, and no magnetic flux leak below the bottom of the magnet-segment. Such arrangement of magnets can also eliminate any magnetic flux loss below the bottom magnets, and should be able to double the magnetic field strength 200 above the top magnets.

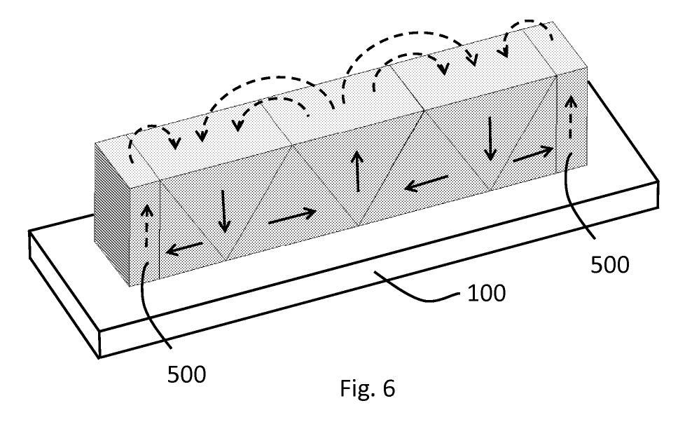

In reference to FIG. 4, FIG. 6 illustrates an alternative embodiment of the permanent magnet-segment of present invention in which the side of the magnet-segment was shielded with side shield plates 500 that are made of soft magnetic materials, such Fe, NiFe, CoFe. With the help of the side shield plates 500, all the magnetic flux at the both ends of magnet-segment will be further confined within the magnet-segment area.

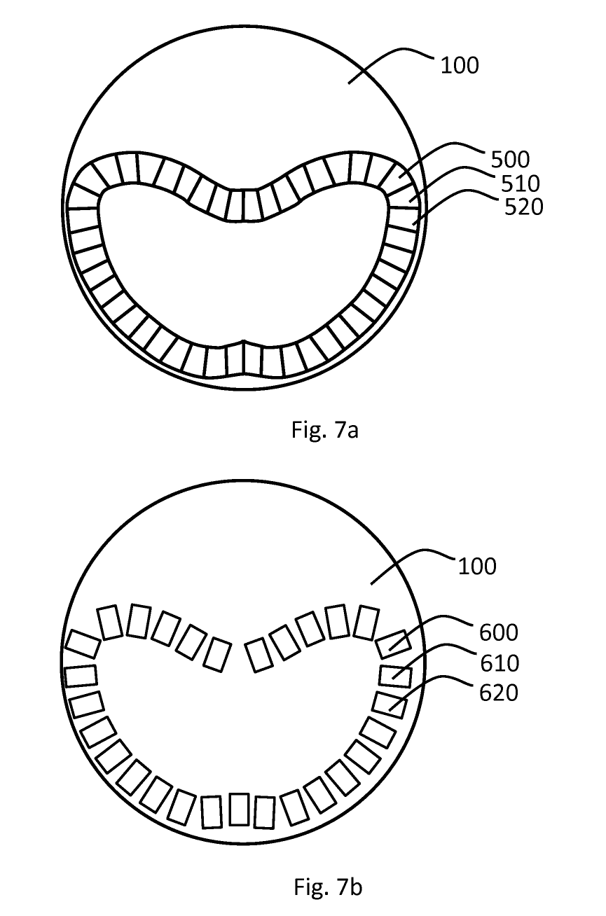

FIG. 7a illustrates a top view of a magnet arrangement of the magnet-segments that can be applied in a rotating magnetron. The magnet-segments, such as 500, 510, 520, are designed and manufactured in different sizes and shapes, which may be adjusted in a manner so as to define a closely packed magnet arrangement to form a “Heart” or “Apple” . . . shape. This magnet arrangement will ensure absolute no magnetic flux leaking from its bottom and no fringing magnetic flux loss in between the magnets. All the magnetic field will be enforced on top of the magnet array and acting onto the targets. Thus this magnetron can provide the strongest magnetic field to sputter thick target, especially thick magnetic target, such as, NiFe, CoFe, Ni, Co, CoNiFe, . . . . So the usable target life time can be largely increased. Due to its rotating nature and optimized pattern design, the magnetron can also provide good thickness uniformity and best target usage. With reference to FIG. 7a, FIG. 7b also illustrates a top view of a magnet arrangement of the magnet-segments that can be applied in a rotating magnetron. In this embodiment, the magnet-segments, such as 600, 610 and 620 are of the same size for simplicity, and packed as closely as possible to form a “Heart” or “Apple” . . . shape.

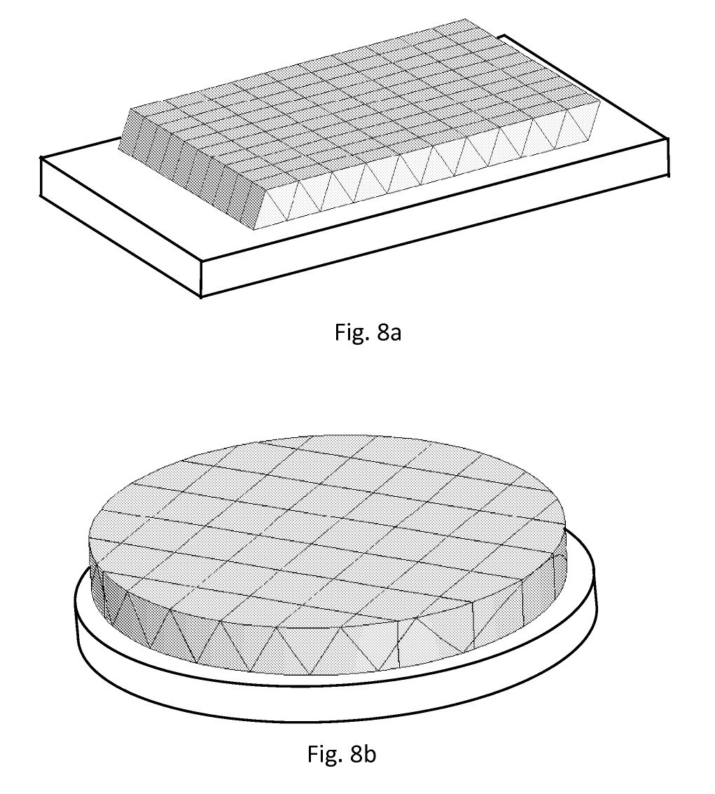

FIG. 8a and FIG. 8b illustrate other embodiments of the present invention that can be used in a stationery planar magnetron. The magnet-segments are closely packed in a square, circular, or other shapes, which can be tailored to a sputtering target size and shape. In this arrangement, since the magnets are closely packed,
1. As compared with conventional dipole magnet arrangement, this embodiment provides more uniform magnetic field created by the magnet s across the surface of the target, and leads to more uniform deposited film;
2. The target usage is improved since the magnetic field are all over the target;
3. Since the magnetic field strength is doubled, this can be used to sputtering much thicker target. This will significantly improve usable target life time, which is especially useful when sputtering magnetic targets, such as NiFe, CoNiFe, CoFe, CoPt . . . .

What is claimed is:

1. A permanent magnets array in a sputtering magnetron that can be used in a magnetron sputtering device to sputtering target materials onto a substrate, comprising
A supporting plate;
An array of magnet-segments for generating magnetic field passing through said sputtering target;
Each said magnet-segment consists of an array of magnets arranged with the magnetization directions of adjacent magnets alternating in directions perpendicular with each other to reinforce said magnetic field on one side of the said array while cancel said magnetic field to near zero on the other side.

2. The permanent magnets array of claim 1 wherein said supporting plate comprises non-magnetic materials;

3. The permanent magnets array of claim 1 wherein said supporting plate comprise also magnetic materials;

4. The permanent magnets array of claim 1 wherein said permanent magnets array rotates about an axis substantially normal to said supporting plate;

5. The permanent magnets array of claim 1 wherein said permanent magnets array oscillates about an axis substantially normal to said supporting plate;

6. The permanent magnets array of claim 1 wherein said permanent magnets array is stationary;

7. The permanent magnets array of claim 1 wherein said permanent magnets are comprised of NdFeB, or SmCo, or AlNiCo;

8. A permanent magnets array in a sputtering magnetron that can be used in a magnetron sputtering device to sputtering target materials onto a substrate, comprising
A supporting plate;
An array of magnet-segments for generating magnetic field passing through said sputtering target;
Each said magnet-segment consists of an array of magnets and two side shield plates. Said array of magnets is arranged with the magnetization directions of adjacent magnets alternating in directions perpendicular with each other to reinforce said magnetic field on one side of said array while cancel said magnetic field to near zero on the other side.

9. The permanent magnets array of claim 8 wherein said supporting plate comprises non-magnetic materials;

10. The permanent magnets array of claim 8 wherein said supporting plate comprises magnetic materials;

11. The permanent magnets array of claim 8 wherein said permanent magnets array rotates about an axis substantially normal to said supporting plate;

12. The permanent magnets array of claim 8 wherein said permanent magnets array oscillates about an axis substantially normal to said supporting plate;

13. The permanent magnets array of claim 8 wherein said permanent magnets array is stationary;

14. The permanent magnets array of claim 8 wherein said the permanent magnets are comprised of NdFeB, or SmCo5, or AlNiCo;

15. The permanent magnets array of claim 8 wherein said side shield plate is comprised of Fe, or NiFe, or CoFe.
